(19) United States
(12) Patent Application Publication
(10) Pub. No.: US 2002/0035468 A1
(43) Pub. Date: Mar. 21, 2002

(54) Audio transmission system having a pitch period estimator for bad frame handling

(76) Inventor: Rakesh Taori, Eindhoven (NL)

Correspondence Address: U.S. Philips Corporation, Intellectual Property Department, 580 White Plains Road, Tarrytown, NY, 10591, US

(21) Appl. No.: 09/935,236

(22) Filed: Aug. 22, 2001

(30) Foreign Application Priority Data
Aug. 22, 2000 (EP) 00202929.6

(51) Int. Cl. G10L 11/04; G10L 21/00

(52) U.S. Cl. 704/207

(57) ABSTRACT

An audio transmission system comprises: a decoder for converting a frame organized bitstream into an audio output representation; and a bad frame processing means arranged for detecting bad or disturbed frames in the bitstream. The audio transmission system further comprises a pitch period estimator coupled to said decoder audio output for estimating the pitch period of the audio representation and the pitch period estimator is further coupled to the bad frame processing means for replacing the audio output during a detected bad frame by a pitch period determined representation of said audio output. As a consequence no smoothing is necessary at the edges of neighboring frames.

The present invention relates to an audio transmission system comprising: a decoder for converting a frame organized input bitstream into an audio output representation; and a bad frame processing means arranged for detecting bad frames in the bitstream.

The present invention also relates to a method for converting a frame organized bitstream into an audio output representation, wherein bad frames are detected in the bitstream.

Such an audio transmission system and method are known from an article, entitled “Improved ADPCM Voice Transmission for TDMA-TDD Systems”, by O. Nakamura et al, 43rd IEEE Vehicle Technology Conference, Meadowlands Hilton, Secaucus, N.J., USA, May 18-20, 1993, pp301-304. The known transmission system uses noise detection and a Cyclic Redundancy Check (CRC) to decide that a pulse code modulated (PCM) voice output signal of an ADPCM decoder comprises an erroneous frame or burst. In a bad frame handler, which is arranged for processing the detected bad frames the erroneous PCM frame or burst is being replaced by a previous errorless burst, where after discontinuities at the edges of neighboring bursts are smoothed using running average techniques, in order to overcome resulting residual click noise in the processed voice signals. This PCM burst replacement scheme improves clarity and quality of the voice signals. It is however a disadvantage of the known audio transmission system that smoothing is required for reducing click noise in the processed voice signals.

Therefore it is an object of the present invention to provide an improved audio transmission system and corresponding method, which do not necessitate smoothing means and corresponding smoothing means respectively.

Thereto the audio transmission system according to the invention is characterized in that the audio transmission system further comprises a pitch period estimator coupled to said audio output for estimating the pitch period of the audio representation; and that the pitch period estimator is further coupled to the bad frame processing means for replacing the audio output during a detected bad frame by a repeat part, which is synchronous to the estimated pitch period.

Accordingly the method according to the invention is characterized in that a pitch period of the audio output is being measured, and that the pitch period is used as a measure for determining the length of a previous audio output representation, which is at least partly used for replacing said audio output during detection of the bad frame.

It is an advantage of the audio transmission system according to the invention that by inclusion of pitch period information in a repeated bitstream during the bad frame no smoothing is required, as the pitch information is retained in the actual processed audio bitstream. Consequently the presence of unpleasant and annoying artifacts, such as clicks in the final audio bitstream will be reduced. Furthermore substitution of the bits of a detected bad frame by the pitch period determined audio representation is a very simple to implement solution, only requiring simple hardware and/or software, thus making the method according to the present invention particularly suitable for implementation in for example DECT phones. The basic idea behind the invention is the notion that the pitch period embodies long term correlation information of the audio output, which may be exploited effectively for reducing audio clicks, if retained in case of frame transmission errors.

An embodiment of the audio transmission system according to the invention is characterized in that the bad frame processing means comprise bitstream buffer means containing a representation of the previous audio output.

Advantageously the bitstream buffer means are capable of operating on bitstream level, and are capable of continuously storing and maintaining bits corresponding to previous samples of an original audio, voice and/or speech signal for possible future use as a repeat part.

A further embodiment of the audio transmission system according to the invention is characterized in that the bitstream buffer means comprise indexing means providing a buffer read index, whose value is related to the estimated pitch period for selecting the repeat part from the representation which is stored in the bitstream buffer means.

It is an advantage of the audio transmission system according to the invention that the indexing means provide a cost effective way of implementing a buffer read index, whose index value varies in accordance with the estimated pitch period.

Advantageously any kind of decoder may be applied in the audio transmission system according to the invention, such as a Pulse Code Modulator, in particular a Differential PCM decoder or ADPCM decoder.

Other possible embodiments of the audio transmission system according to the invention are set out in the further appended subclaims.

At present the audio transmission system and corresponding method according to the invention will be elucidated further together with their additional advantages while reference is being made to the appended drawing, wherein similar components are being referred to by means of the same reference numerals. In the drawing:

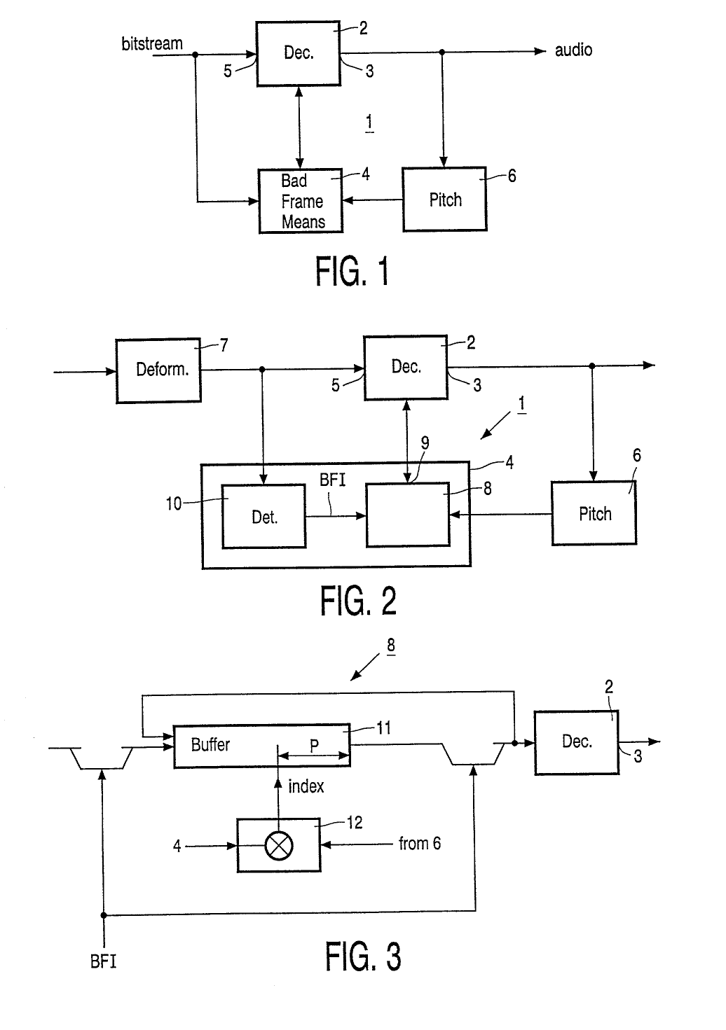

FIG. 1 shows a general scheme of possible embodiments to implement the audio transmission system according to the invention;

FIG. 2 shows a detailed embodiment of the audio transmission system according to the invention; and

FIG. 3 shows a possible implementation of a bad frame processing means for application in the audio transmission system according to the invention.

FIG. 1 shows a general outline of an audio transmission system 1. Such an audio transmission system 1 can be used in communication devices, such as for example telephone devices. A frame organized for example PCM modulated bitstream, in particular an ADPCM modulated bitstream, such as used in a well known DECT phone system is received from a transmitter (not shown). For the sake of simplicity the remainder of this description shall relate to the DECT standard, wherein one frame (=10 msec.) of an original audio signal for example comprising speech is represented by 80 samples. One sample may for example be quantized by 4 bits, resulting in 32 kbit/sec. There is also a well known Cyclic Redundancy Check (CRC) prescribed by the DECT standard, which checks the integrity of the transmission.

The ADPCM bitstream, which is built up in frames, is input to a decoder 2 of the system 1, which provides a decoded audio representation at its decoder output 3. The bitstream input may be corrupted for example by all kinds of noise, clicks, fading, multipath and the like, which results in annoying artifacts in the resulting audio signal. The audio system 1 further comprises bad frame processing means 4 coupled to an input 5 of the decoder 2 for detecting a bad frame in the bitstream. Normally if no bad frames are detected by the bad frame processing means 4 the decoder 2 provides a continuous audio output representation, which is processed further. Upon detection of a bad frame the continuous audio output representation is during the bad frame being replaced by a repeat part, which comprises replacement bits. These replacement bits are being determined by the period of the pitch of the voice output signal on output 3. Generally, but not necessarily, the CRC is being used as at least one of the bad frame signaling indicators.

Thereto the audio transmission system 1 additionally comprises a pitch period estimator 6, which is coupled between the decoder output 3 and the bad frame processing means 4. The pitch period estimator 6 estimates the pitch time period duration or length of the audio representation on output 3. The bad frame processing means 4 thus take the estimated pitch period as a measure for copying a corresponding number of bits from a previous part of the input bitstream on input 5. In particular that part of the input bits are copied to form a repeat part, which part represents the audio signal at a distance of one pitch period before the occurrence of the bad frame. These copied bits in the repeat part form the replacement bits which are decoded again during the presence of the bad frame. Because the pitch, which represents the long term correlation of the audio signal, is also retained in the audio output representation during bad frames the edges of the replacement bits need no smoothing, as they provide only reduced disturbing click noise. In fact the pitch of the audio signal at output 3 does not change significantly during one or more bad frames, so an annoying phase jump in the pitch frequency is not likely to occur.

FIG. 2 shows a more detailed embodiment of the audio transmission system 1 of FIG. 1. After deformatting the ADPCM input bitstream in a deformatter 7, which separates the ADPCM decoder input signal from various control and additional layer communication data, the decoder output signal is conveyed to a bitstream handler 8. The bitstream handler 8 normally conveys the errorless input signal to its handler output 9. Upon detection of a bad frame in the deformatted input bitstream by a bad frame detector 10 in the bad frame means 4, the handler 8 is instructed to operate on the bitstream itself by replacing the output bitstream on handler output 9 by the above described pitch period determined representation of the previous signal on the output 9 to retain pitch information therein. The replaced bitstream is again applied to the decoder 2.

FIG. 3 shows a possible implementation of in particular the bit stream handler 8 for application in the audio transmission system 1 of FIGS. 1 and 2. The bit stream handler 8 comprises bitstream buffer means 11 for providing replacement bits on output 9 in case of detection of a bad frame by the detector 10. The buffer means 11 are being filled with deformatted actual bits from the input bitstream on input 5. However only if a bad frame is detected by the detector 10, which is indicated by the setting of a Bad Frame Indicator (BFI) flag, a repeat part of the actual bitstream content of the buffer means 11 is used for replacing the audio output on output 9. The part, in particular its length, that is the number of bits is dependent on the pitch period determined by the pitch period estimator 6, which is coupled through the bitstream handler 8 between the output 9 and the bad frame processing means 4. Thereto the bitstream buffer means 11 comprise indexing means 12 providing a buffer read index, whose value is related to the estimated pitch period. Suppose a maximum pitch period is in practice limited to 20 msec. Then a length of 640 bits of the buffer means 11 is sufficient for a DECT configuration. The buffer read index is then obtained by multiplying the determined pitch by “4” so as to make a conversion from the sample domain to the bitstream domain. The read index indicates where the replacement bits for the ADPCM decoder 2 will start. If for instance the pitch period p equals 85 samples, then the index points to 340 in the buffer 11 and the replacement bits can be formed by the first 320 bits in the buffer for replacement of bad frame bits of the bad frame. The remaining 20 bits are not used. So the following equation holds:

Replacement_Bit[i}=Bitstream_Buffer[i−4p] (1)

With 0≦i<320, and p is the pitch period in samples.

If however the pitch period p is less than 80 samples, say for instance 30 samples, then several strategies could be followed. Firstly a multiple of 30 say 90 samples can be chosen to apply equation (1). Secondly the 30 samples can be repeated as long as necessary to fill up the output bitstream during a bad frame. More bitstream strategies could at wish be applied. The pitch period estimation can be made advanced by making an estimate based on extrapolation of a trend in the pitch of the past. Or some sub-sample pitch period resolution can be used instead of just using an integer pitch period.

Whilst the above has been described with reference to essentially preferred embodiments and best possible modes it will be understood that these embodiments are by no means to be construed as limiting examples of the devices concerned, because various modifications, features and combination of features falling within the scope of the appended claims are now within reach of the skilled person.

1. An audio transmission system comprising: a decoder for converting a frame organized input bitstream into an audio output representation; and a bad frame processing means arranged for detecting bad frames in the bitstream; characterized in that the audio transmission system further comprises a pitch period estimator coupled to said audio output for estimating the pitch period of the audio representation; and that the pitch period estimator is further coupled to the bad frame processing means for replacing the audio output during a detected bad frame by a repeat part, which is synchronous to the estimated pitch period.

2. The audio transmission system according to claim 1, characterized in that the bad frame processing means comprise bitstream buffer means containing a representation of the previous input bitstream.

3. The audio transmission system according to claim 2, characterized in that the bitstream buffer means comprise indexing means providing a buffer read index, whose value is related to the estimated pitch period for selecting the repeat part from the representation which is stored in the bitstream buffer means.

4. The audio transmission system according to one of the claims 1-3, characterized in that the decoder is a Pulse Code Modulator, in particular a Differential PCM decoder and/or an Adaptive DPCM decoder.

5. The audio transmission system according to one of the claims 1-4, characterized in that the bad frame processing means comprises a bad frame detector.

6. The audio transmission system according to claim 5, characterized in that the bad frame detector is arranged to perform a Cyclic Redundancy Check (CRC).

7. The audio transmission system according to one of the preceding claims embodied as a communication device, such as a telephone device, a speech device, a voice device or the like.

8. A method for converting a frame organized bitstream into an audio output representation, wherein bad frames are detected in the bitstream, characterized in that a pitch period of the audio output is being measured, and that the pitch period is used as a measure for determining the length of a previous audio output representation, which is at least partly used for replacing said audio output during detection of the bad frame.
